(19) United States
(12) Patent Application Publication
(10) Pub. No.: US 2004/0045950 A1
(43) Pub. Date: Mar. 11, 2004

(54) Electric oven with pivoting heating element

(76) Inventors: Jean-Marie Balandier, Talant (FR); Dominique Antoine, Cleurie (FR)

Correspondence Address: BROWDY AND NEIMARK, P.L.L.C., 624 NINTH STREET, NW, SUITE 300, WASHINGTON, DC, 20001-5303, US

(21) Appl. No.: 10/470,538

(22) PCT Filed: Jan. 25, 2002
(86) PCT No.: PCT/FR02/00318

(30) Foreign Application Priority Data
Jan. 30, 2001 (FR) 01/01239

(51) Int. Cl. A21B 1/00

(52) U.S. Cl. 219/404

(57) ABSTRACT

The invention concerns an electric oven (1) comprising a generally parallelepiped internal volume (3), having top (8) and bottom (7) horizontal walls and side walls (5, 6); and at least a heating element (20) consisting of one or several substantially coplanar heating zones (21, 22), capable of taking up several positions inside the internal volume (3). The invention is characterised in that said heating element (20) is mounted pivoting about an axis (24) perpendicular to the side walls (5, 6) and mobile between two heating positions, namely: a first position wherein it is located proximate to the bottom horizontal wall (7); a second position wherein it is located substantially horizontal at a specific distance from the top horizontal wall (8).

### TECHNICAL FIELD

The invention relates to the field of household appliances, and more precisely to that of cooking appliances. More specifically, it concerns an electric oven wherein the heating elements can be reconfigured inside the oven in order to modify the heating properties.

### PRIOR ART

Electric ovens generally include heating elements constituted by electrical resistors which, when a current is flowing through it, dissipates an energy that serves to heat the food. This energy can be dissipated in the form of radiation with or without the use of reflective zones. This energy can also be dissipated by conduction in order to heat an element such as a shelf or a rack on which the food sits.

An electric oven can be used in different cooking modes to heat food portions of various sizes.

Thus, electric ovens of small size can be used, in particular, as toasters. It is then necessary for the heating elements to be relatively close to the slices of bread to be heated.

Electric ovens of small size can also be used to heat larger portions of food, and they then work like traditional electric ovens. In this case, the heating elements must be farther away in order to allow the food to be heated to be inserted into the oven.

Thus, there is a need to be able to configure the heating elements in order to allow the oven to work in several cooking modes.

It has been proposed in the past that the heating elements of an oven be made movable in order to allow them to occupy different positions inside the internal volume of the oven.

Thus, U.S. Pat. No. 3,281,575 describes an oven equipped with a pair of clad resistors. These resistors are each capable of pivoting relative to the side walls in such a way that their height within the internal volume of the oven is adjustable. This structure makes it possible to position the heating resistors optimally, based on the thickness of the food to be cooked. However, an oven of this type requires a pivoting mechanism for moving the two heating elements concomitantly, which is disadvantageous in terms of the reliability and the cost price of the oven.

U.S. Pat. No. 3,522,414, proposes that an oven be equipped with a heating element capable of pivoting inside the internal volume of the oven. More precisely, this heating element, which is constituted by a coil resistor, can pivot inside the oven at the level of two articulation points located on the lateral faces of the internal volume.

In this way, the heating element can move from an operating position in which it is located near the roof of the oven, to a retracted position in which it is disposed vertically, near the vertical back wall of the oven, when it is not in operation. An oven of this type has the major disadvantage of not allowing the position of the heating element to be adapted to different types of foods to be cooked.

Also, U.S. Pat. No. 3,982,096 describes an electric oven equipped with a heating element than can assume two positions inside the internal volume of the oven. More precisely, this oven includes a first heating element located near the roof of the oven and a second element that can be connected to the inside of the oven in two positions. Thus, this second heating element is equipped with a plug connector that can be plugged into a complementary receptacle located on the back wall of the oven. This plug connector can be plugged in from two different positions. In a first position, the heating element is located near the bottom wall, or floor, of the oven. When the plug connector of the heating element is plugged in from the opposite position, the heating element is located at approximately the mid-height of the oven.

This oven has many disadvantages, including the fact that connecting the heating element to only one wall of the oven requires the use of a connector that is particularly strong, and therefore expensive. Moreover, the oven can only be reconfigured when the heating element has been completely cooled.

A first problem that it is proposed for the invention is that of a facilitated reconfiguration of the oven, at any time. Another problem resolved by the present invention is that of the mechanical complexity of the mechanism for displacing the heating element, which must be simple for cost reasons, but reliable.

### DESCRIPTION OF THE INVENTION

Hence, the invention concerns an electric oven. An oven of this type includes, in a known way, a generally parallelepipedic internal volume, which has side walls and horizontal top and bottom walls, generally called the “roof” and the “floor,” respectively. Such an oven also comprises, in a known way, at least one heating element constituted by one or more substantially coplanar heating zones, this heating element being capable of assuming several positions inside the internal volume of the oven.

According to the invention, this oven is characterized in that the heating element is pivot-mounted about an axis perpendicular to the side walls, and in that this heating element is capable of being moved between the two heating positions, i.e.:

a first position in which it is located near the horizontal bottom wall of the oven,

a second position in which the heating element is approximately horizontal, located at a given distance from the horizontal top wall.

In other words, the heating element of the oven according to the invention has a substantially flat geometry, and it is designed to be able to be turned over inside the oven so as to move from a heating position in which it is located near the floor or the roof of the oven, to another heating position in which it is located at a distance from said floor and roof walls. In this second position, the heating element is preferably located somewhere between ⅓ and ⅔ the height of the internal volume of the oven.

This second working position is used, in particular, for quickly reheating dishes, even frozen dishes, and for quickly toasting slices of bread.

Thus, by pivoting 180°, the heating element moves from one heating position to the other. This rotation, without having to connect or disconnect the heating element in order to position it in one working position or the other, prevents premature aging of the heating element.

Advantageously, in practice, the heating element is pivot-mounted relative to the two side walls. This provides the assembly with good rigidity and shock resistance. It also limits the deformation of the heating element that is inevitably observed as it ages.

Advantageously, the heating element includes alternating zones capable of generating different levels of power when in operation. It may in fact seem appropriate, either due to limited available power or in order to optimize the distribution of energy, but also in order to avoid overheating the walls, particularly the side walls, to limit the power emitted by the heating element in certain zones of the oven.

One of the possible embodiments of the heating element according to the present invention consists in straight zones that extend approximately across the width of the oven, connected to one another by curved zones. Such a configuration allows good heat distribution across the width of the oven.

Advantageously, the heating element is a clad type and the curved zones have a lower power density than the straight zones. The straight zones are preferably disposed perpendicular to the side walls of the oven. Of course, depending on the volume and the heating power required, it is possible to increase the number of these straight zones, while retaining a generally flat shape for the heating element.

In certain variants, the heating element can also be constituted by a single resistor that has an undulating or coiled shape but remains in the main plane of the heating element.

Advantageously, the zone of the heating element that connects it to the pivot axis has a lower power density than the straight zones.

Advantageously, the orthogonal projection of the pivot axis onto the plane defined by the straight zones is located within the area delimited by said straight zones.

In other words, the pivot axis is not only offset relative to the main plane of the heating element, it is also offset relative to the mid-plane of the heating element. The projection of the pivot axis onto the heating element is therefore closer to one edge of the latter than the other.

The heating element is therefore off-center inside the volume of the oven. The offset of the pivot axis relative to the overall space taken up by the heating element is determined so as to allow the heating element to turn over inside the oven, and to optimize the heating performance.

It is thus possible, because of the off-center disposition of the axis with respect to one of the edges of the heating element, to dispose the latter very close to the bottom wall, which would not have been possible with a symmetrical configuration, which would have required positioning the heating element farther away from the bottom wall, which would have reduced the cooking performance.

According to one particular embodiment, the heating element includes two straight zones, the pivot axis in this case being located at a different distance from each of the two straight zones, as explained above.

In this way, when the pivot axis is located at approximately the mid-depth of the oven, the heating element extends not only toward either the front or the rear part of the oven, but also extends substantially toward the complementary part, i.e., the rear or the front of the oven, respectively. Such a configuration makes it possible, particularly in the traditional cooking mode, in which the movable heating element is in its first heating position near the floor of the oven, to limit the differences in heat distribution inside the oven.

Advantageously, in practice, when the heating element is near the floor of the oven, i.e., in its first working position, it is essentially located in the rear part of the oven. Conversely, when the heating element is at a distance from the floor of the oven, i.e., in its second working position, it is essentially located in the front part of the oven, that is, fairly close to the entrance of the oven. The opposite situation is also conceivable without going outside the scope of the present invention.

As already mentioned, the heating element extends substantially into the complementary (front or rear) part of the oven.

In practice, however, the first case envisioned permits, when the heating element is in its second working position, which essentially corresponds to a cooking mode for toasting bread or quickly reheating small food items or frozen dishes, it is preferable to dispose heating zones near the entance of the oven, in order to limit the risk of burns, particularly by providing a better view during the handling of said elements.

Advantageously, the oven includes a second heating element located near the horizontal wall opposite the one that the pivoting heating element faces when it occupies the first operating position.

In other words, the oven can be configured in one of two operating positions. In the first position, the two heating elements are each located on a horizontal wall of the oven, which in this case works like a traditional oven. In the second position, when the pivoting heating element is near the mid-height of the oven, this latter has two separate spaces, thereby allowing the simultaneous cooking of two foods. Moreover, in this second configuration, the foods to be cooked are closer to each heating element, which increases the cooking speed.

Advantageously, in practice, the positioning of the pivoting heating element is determined so that the second, fixed heating element is disposed approximately facing the pivoting heating element, when the latter is located at a distance from the floor and roof walls, i.e., in its second working position. This configuration is particularly well adapted to cooking or heating slices of bread or toast.

Advantageously, the power of the pivot-mounted heating element can be modulated according to the desired cooking mode and/or according to the position of said element, thus making it possible to adapt the energy applied to the food based on the volumes delimited by the heating element or elements.

In keeping with this same idea of adapting the heating power of the various heating elements, one of the embodiments of the invention proposes that the pivoting of the heating element be linked to at least one electrical switch connected to the power supply of the heating elements present in the oven. It may in fact seem advantageous to offer, automatically when the pivoting heating element moves from one working position to another, either a different distribution of power among the various heating elements, or a modulation in the power supply of said pivoting element, so that the various heating elements generally operate differently depending on the position of the pivoting heating element.

Advantageously, in any of the operating modes offered, one of the embodiments associates the pivot-mounted heating element with a reflective element that makes it possible to direct the radiation. This accessory is important when the heating element is in its second working position, so that the radiation is preferably directed toward the food to be reheated. This situation is present particularly when the user wants to toast slices of bread between a heating element located at the roof and the pivoting heating element in its second working position. The reflective element is then disposed underneath the pivoting heating element.

Advantageously, the reflective element includes a crumb or cooking juice collector, which generally facilitates the overall cleaning of the oven.

According to another embodiment, the pivot-mounted heating element is associated with a radiation absorbing element attached to a baking sheet. This sheet is preferably disposed above the pivoting heating element, and it makes it possible to distribute the power delivered by the heating element when cooking or reheating dishes like pies or pizza.

Complementing the different variants proposed, the movable heating element is advantageously pivot-mounted relative to the two side walls of the oven by rotating toward the rear of the oven, and can occupy a third position in which the heating element is approximately perpendicular to the horizontal walls. This third working position makes it possible to add to the various cooking modes available in the oven. The user can, for example, cook rotisserie-style, with said pivoting heating element in a vertical position at the back of the oven and a fixed heating element on the roof, thus freeing up the floor, particularly for collecting juices.

In practice, the oven can include a rotating knob that controls the pivoting of the heating element. This knob can be located either in an extension of the pivot axis, i.e. on a lateral face of the oven. It can also be located on the front face of the oven, in which case an angular gear mechanism, through a cable or a beveled gear or another lever, transforms the movement of the control device into a pivoting of the heating element. This control knob makes it possible to avoid any direct user contact with the resistor, and thus any risk of accidents.

Advantageously, in practice, the internal volume of the oven can include spaces designed to receive racks, respectively located at approximately one-third and two-thirds the height of the internal volume.

In this way, it is possible to dispose the foods optimally relative to the heating element, especially when the latter is at the mid-height of the oven.

### BRIEF DESCRIPTION OF THE FIGURES

The ways in which the invention may be implemented, and the advantages it provides, will clearly emerge from the description of the following exemplary embodiment, given as a nonlimiting example, and supported by the attached figures, in which:

FIGS. 1 and 2 are schematic views in perspective of an oven according to the invention, shown with two different positions of the pivoting heating element.

FIG. 3 is a central longitudinal section of the oven of FIGS. 1 and 2, respectively.

FIG. 4 is a side view of an oven according to the invention, illustrating an embodiment of the device for controlling the pivoting of the heating element.

### EMBODIMENT OF THE INVENTION

As already mentioned, the invention concerns an electric oven that includes a heating element whose position can be adapted inside the volume of the oven, in accordance with the desired operating mode.

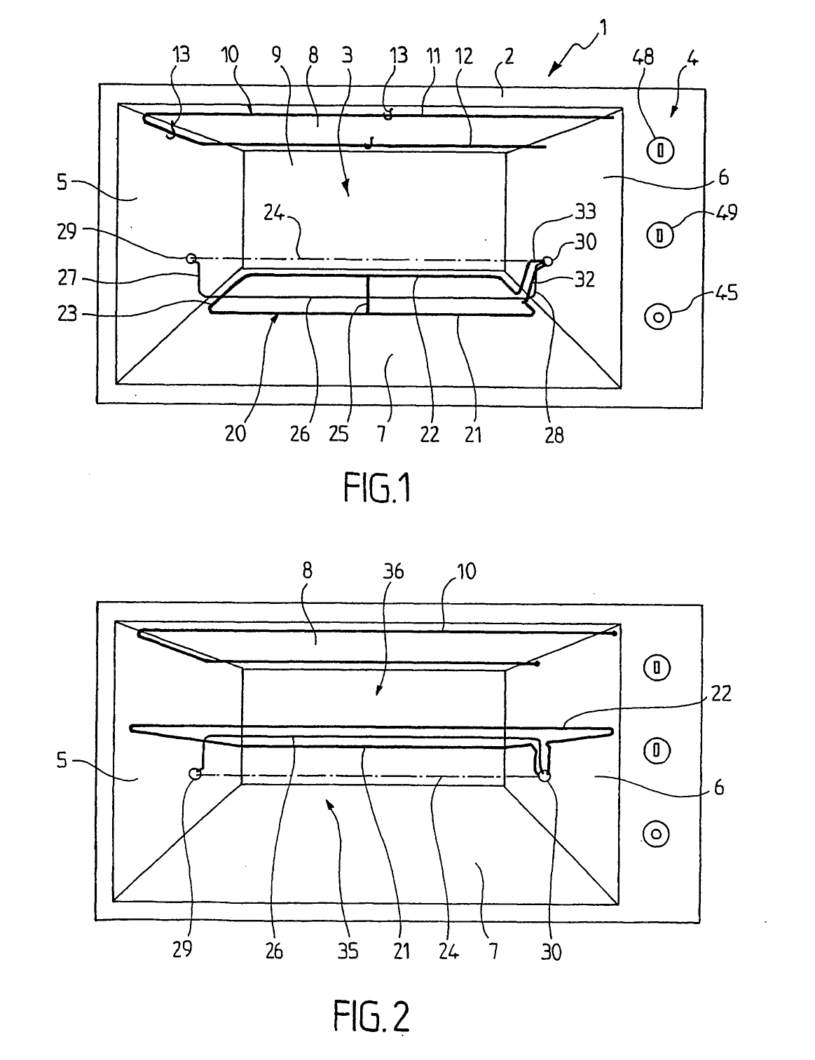

More precisely, the oven (1) illustrated in FIG. 1 comprises an external fairing (2) that defines an internal volume (3), as well as a side zone (4) used for controlling its operation.

More precisely, the internal volume (3) is defined by:

side walls (5, 6)

a bottom wall (7), also called a “floor,”

a top wall (8), also called a “roof”

and a back wall (9).

The opening of the oven that gives access to the internal volume can be closed by a door, not represented. Certain oven models do not include a door.

The oven (1) represented in FIG. 1 includes a fixed heating element (10) located near the roof (8) of the oven. This heating element (10) is constituted by a U-shaped clad resistor whose terminal parts (11, 12) run through the side wall (6) of the oven.

The fixed heating element (10) is held in place relative to the roof (8) by means of suitable mounting elements, such as the hooks (13) illustrated in FIG. 1.

Of course, the invention is not limited to this geometric shape alone, but covers all heating element shapes, which could be varied based on the need for heating power. Likewise, the present invention also covers heating elements other than clad elements, such as quartz rods, ceramic glass plates, . . . .

According to the invention, the oven (1) is equipped with a second heating element (20) that is capable of being pivoted inside the internal volume (3) of the oven. More precisely, in the embodiment illustrated, the pivoting heating element (20) includes two heating rods (21, 22) that are connected by a rod that heats very little or not at all (23). In practice, when the pivoting heating element (20) is an element of the clad type, it includes either drawn rod portions or rod portions of larger diameter such that the power density inside these rods is lower than that of the so-called heating rods. These connecting portions, which heat much less than the straight heating parts, are often called “cold parts” even though, in operation, they have a temperature higher than the ambient temperature.

The presence of cold parts can make it possible to limit the total power of the heating element to a given value, which may be a standardized constraint. It also makes it possible to avoid overheating the lateral parts or encouraging heat loss through the side walls of the oven.

This configuration constitutes only one exemplary embodiment. It is of course, conceivable, without going outside the scope of the invention, for the heating element (20) to include only one heating zone, extending along approximately the entire length of said heating element.

The general shape of the heating element is rectangular. In the embodiment illustrated, the heating element also comprises a crossbar (26) that supports the rest of the heating element, i.e., the heating rods (21, 22) and the non-heating rod (23). In the embodiment illustrated in FIG. 1, the two heating rods (21, 22) are joined at their center part by a brace (25), which is itself joined to the crossbar (26), to give the assembly rigidity.

The bar (26) comprises, at each of its ends, an inclined portion (27, 28), which is itself coupled with a ring (29, 30) mounted in the side walls (5, 6). These rings (29, 30) serve as bearings, and are made from a material having good frictional resistance properties, in order to pivot reliably inside the sheet metal forming the enclosure of the internal volume (3). In an economical variant of embodiment of the invention, only one ring is used in one of the walls. The second wall in this case includes a simple opening that allows the heating element (20) to rotate.

The terminals (32, 33) of the heating element are also coupled with the ring (30), in order to supply electrical power to the resistor. In the exemplary embodiment presented, these connecting terminals are also cold parts, as explained above. It is conceivable, without going outside the scope of the invention, for each of the connecting terminals (32, 33) of the heating element (20) to be connected to one of the rings (29, 30) on the opposing walls.

In the embodiment illustrated in FIG. 1, the pivoting heating element (20) is disposed near the floor (7) of the oven.

According to the invention, the heating element (20) can be pivoted into the position illustrated in FIG. 2, in which it is located at approximately the mid-height of the internal volume (3) of the oven. This pivoting or turning motion about the axis (24) connecting the rings (29, 30), is produced by a lifting of the heating rod (22). Thus, in the configuration of FIG. 2, the internal volume (2) of the oven is divided into two superposed half-spaces (35, 36).

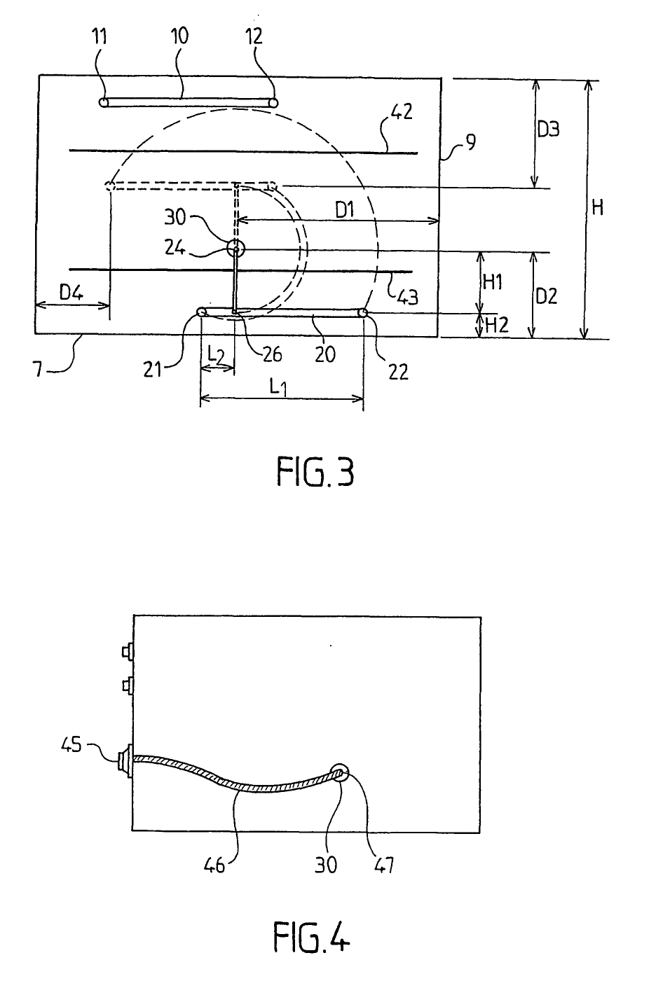

The geometry of the heating element and its positioning, as well as that of the pivot axis, are determined so as to optimize the heating power, while allowing the characteristic pivoting movement. These dimensional parameters are more clearly visible in FIGS. 3 and 4. Thus, the heating element has a length L1, measured in the direction of the depth P of the oven, that is close to half of this depth P, or longer. The rings (29, 30), and more precisely the pivot axis (24) of the heating element (1), is located at a distance D1 from the back wall (9) of the oven, at approximately mid-depth. This pivot axis is located at a height D2 measured from the floor (7) of the oven.

The heating element (20) is positioned relative to the pivot axis (24) so as to be off-center. Thus, the support bar (26), perpendicular to the plane defined by the rods (21, 22), is closer to the heating rod (21) than the heating rod (22). This bar also represents the orthogonal projection of the pivot axis (24) in the plane defined by the two rods (21, 22).

More precisely, this support bar (26) is separated by a length L2 from the heating rod (21), this length being distinctly less than half the length L1 of the heating element. In practice, the length L2 is between 20 and 45% of the length L1.

The distance H2 separating the floor (7) from the plane of the heating element (20) is determined so as to allow the passage of the heating rod (21) as it pivots.

Due to the off-center disposition of the pivot axis relative to the rods, and particularly the short distance L2 separating the support bar (26) from the rod (21) that defines one of the longitudinal edges of the heating element, it is possible to position said heating element very close to the horizontal floor wall.

The distance H1 separating the pivot axis (24) from the plane of the heating element (20) is adjusted based on the dimensions of the oven and on the functions to be implemented, and particularly on the desired second working position. In the proposed example, the second working position is located in the top half of the oven, which places the pivot axis in the bottom third of the height of the oven.

In the proposed example, and as illustrated in FIG. 3, the heating element is positioned nearer the back of the oven, while the fixed heating element (10) is located nearer the opening end of the oven. When the pivoting heating element (20) has been turned over and is in the configuration illustrated by dotted lines in FIG. 3, the heating element (20) is located substantially facing the fixed heating element (10), at a distance D3, close to H/2 in the proposed example. The distance D4 that separates the heating rod (22) from the opening of the oven is on the order of 50 millimeters.

In the configuration illustrated in FIG. 3, the oven can receive one or two racks or shelves (42, 43). Each of these shelves (42, 43) facing a heating element (10, 20), the distance separating them from these elements being between one-third and one-quarter of the height H of the oven. It is equally possible to provide a rack placement equidistant from the two heating elements when the movable heating element is located near the floor wall, i.e., in its first working position.

The various positions of the movable heating element (20) do not interfere with the sliding of the racks.

These various potential positions of the racks make it possible to allow multiple operating modes of the oven, which works either like a traditional oven, or in “quick-cooking” mode, in which the volume of the oven is reduced by the rotation of the movable heating element into the second working position, the latter mode also making it possible to cook two foods simultaneously with good heating efficiency taking into account the proximity of the heating elements to the racks (42, 43).

In order to improve cooking performance, particularly when the movable heating element (20) is in its second working position, at a distance from the floor and roof walls, it is associated with a plate. The latter can be either a reflective plate that is located underneath the heating element, making it possible to direct the radiation, or an absorbent plate associated with a baking sheet that is positioned over the heating element (20). This plate can be a “multifunction” plate, and can incorporate a crumb or cooking juice collector.

There can then be provided either a precise space in the oven for such plates, or specific devices for attaching the plates to the movable heating element.

In practice, as illustrated in FIG. 4, the pivoting of the heating element (20) can be obtained by actuating a control knob (45) located on the front face of the oven.

This knob (45) is connected to a torsion cable (46) itself fixed at its opposite end (47) to the pivoting ring (30). Thus, the movement of the knob (45) is translated directly into the pivoting of the pivoting heating element.

Of course, other variants of actuation can be envisioned, such as a knob located along the pivot axis on a lateral face of the oven, or even a manual actuation.

The oven can be equipped, as illustrated in FIG. 1, with various other control knobs such as a thermostat (49) or a timer (48).

It follows from the above that the oven according to the present invention offers many advantages, including the possibility of changing from a traditional oven configuration, offering a single-volume cooking space, to a multifunction oven offering two half-size cooking spaces. This configuration is very easy to achieve, with a minimum of mechanical parts, which improves the reliability of the assembly.

1. Electric oven (10) comprising:
a generally parallelepipedic internal volume (3), having horizontal top (8) and bottom (7) walls, and side walls (5, 6);
and at least one heating element (20) constituted by one or more substantially coplanar heating zones (21, 22), capable of assuming several positions inside the internal volume (3), characterized in that said heating element (20) is pivot-mounted about an axis (24) perpendicular to the side walls (5, 6) and is capable of being moved between two heating positions, i.e.:
a first position in which it is located near the horizontal bottom wall (7),
a second position in which it is approximately horizontal, located a given distance from the top horizontal wall (8).

2. Oven according to claim 1, characterized in that the heating element, in its second position, is located between ⅓ and ⅔ of the height of the internal volume of the oven.

3. Oven according to one of the preceding claims, characterized in that the heating element (20) pivots 180° between the first and second positions.

4. Oven according to one of the preceding claims, characterized in that the heating element (20) is pivot-mounted relative to the two side walls (5, 6).

5. Oven according to one of the preceding claims, characterized in that the heating element (20) includes alternating zones capable of generating different levels of power when in operation.

6. Oven according to one of the preceding claims, characterized in that the heating element (20) is a clad type and is constituted by straight zones (21, 22) extending substantially across the width of the oven and connected to one another by curved zones.

7. Oven according to the preceding claim, characterized in that the curved zones have a lower power density than the straight zones (21, 22).

8. Oven according to one of claims 6 or 7, characterized in that the zone of the heating element (20) that connects it to the pivot axis has a lower power density than the straight zones (21, 22).

9. Oven according to one of claims 6 to 8, characterized in that the orthogonal projection of the pivot axis (24) onto the plane defined by the straight zones (21, 22) is located within the area delimited by said straight zones (21, 22).

10. Oven according to one of claims 6 to 9, characterized in that the heating element includes two straight zones (21, 22) and in that the pivot axis (24) is located at a different distance from each of the two straight zones (21, 22).

11. Oven according to one of the preceding claims, characterized in that when the heating element (20) is in the first position, it is located essentially facing the rear part of the horizontal wall (7), whereas when it is in the second position, it is located essentially facing the front part of the horizontal wall (7).

12. Oven according to one of the preceding claims, characterized in that it includes a second heating element (10) located near the horizontal wall (8) opposite the one (7) that the pivoting element (20) faces when it occupies the first operating position.

13. Oven according to claim 12, characterized in that the second heating element (10) is disposed approximately facing the pivoting heating element (20) when the latter is in the second position.

14. Oven according to one of the preceding claims, characterized in that the power of the pivot-mounted heating element can be modulated according to the desired cooking mode and/or according to the position of said heating element.

15. Oven according to one of the preceding claims, characterized in that the pivoting of the heating element is linked to at least one electrical switch connected to the power supply of the heating elements present in the oven.

16. Oven according to one of the preceding claims, characterized in that the pivot-mounted heating element is associated with a reflective element for directing the radiation.

17. Oven according to the preceding claim, characterized in that the reflective element includes a crumb or cooking juice collector.

18. Oven according to one of claims 1 to 15, characterized in that the pivot-mounted heating element is associated with a radiation absorbing element attached to a baking sheet.

19. Oven according to one of the preceding claims, characterized in that the movable heating element is pivot-mounted relative to the two side walls (5, 6) by a rotation toward the rear of the oven, and can occupy a third position in which the heating element is approximately perpendicular to the horizontal walls (7, 8).

20. Oven according to one of the preceding claims, characterized in that includes a rotating knob (45) that controls the pivoting of the heating element (20).

21. Oven according to claim 12, characterized in that the internal volume (3) includes spaces designed to receive racks (42, 43), respectively located at approximately one-third and two-thirds the height H of the internal volume (3).
